(19) United States
(12) Patent Application Publication
(10) Pub. No.: US 2005/0104051 A1
(43) Pub. Date: May 19, 2005

(54) Wire guide for electrical LB's

(76) Inventor: Carl Greg Neal, Conception Bay South (CA)

Correspondence Address: Carl Neal, 79 Andrews Road, Conception Bay South, NF, A1X 4A2, CA

(21) Appl. No.: 10/986,819

(22) Filed: Nov. 15, 2004

(30) Foreign Application Priority Data
Nov. 13, 2003 (CA) 2,448,048

(51) Int. Cl. B32B 3/06

(52) U.S. Cl. 254/134; 428/99

(57) ABSTRACT

A reusable wire guide used to reduce friction and abrasions on conductor insulations while both feeding and pulling conductors through an electrical conduit LB. The wire guide is made of polymer material. It is a one-piece tool that has a curved body with two holding bracket molded to the main body. The Wire Guide is grooved at one end to allow it to be placed directly on the conduit entrance hole lip of the electrical LB. The wire guide is secured to the LB by holding brackets on the wire guide to the existing screw holes on the electrical LB.

### BACKGROUND OF THE INVENTION

Electrical conductors ran in conduit will have to change direction; in most cases the change in direction is a 90-degree bend in the conduit or the use of an electrical LB. Where an electrical LB is used, the cable has to be feed out and back into the LB openings. When the conductors are feed into the 90-degree conduit entrance holes, there is an ark in the cable; this caused the conductor to rub up against both the cover edge and the conduit entrance hole stop edge. This is where most of the friction occurs while feeding a cable through the 90-degree conduit entrance hole of a LB. This can cause abrasions on the conductor decreasing the insulation properties of the conductor. In the event that the conductors are cold they are stiffer and the abrasion factor increases. These abrasions can be prevented by, attaching the Wire Guild to the LB before the cable is feed into the conduit attachment hole. This will guide the conductors directly to the conduit attachment hole, bypassing the LB cover edge and the conduit entrance hole edge.

If one has to feed conductors into a short run of conduit that is feeding into the straight attachment hole entrance of a LB, the conductors will bring up on the side of the LB and stop. It would be very convenient for the conductors to be guided out without stopping. Hence allowing the conductors to be feed and directed out of the LB from one location. This can be accomplished by, laying the wire guide into the LB and fastening it using the holding bracket to the existing screw hole prior to feeding the cable into the LB.

### DESCRIPTION OF PRIOR ART

1—Prior art of guiding conductors into electrical LB's is U.S. Pat. No. 4,801,118. This technique employs a tubular clip attached to the outer lip of the LB to prevent abrasions to the protective jacket. 1) This method, however, does not guide the conductors into the conduit entrance hole of the LB where abrasions also occur nor does it protect the conductor jacket from the sides of the outer lip of the LB. 2) This method does not guide the conductors, fed into the straight conduit entrance of LB, out of and away from the LB opening.

2—Prior art of guiding conductors into electrical LB's is U.S. Pat. No. 3,944,184. This technique employs the use of rollers attached to the outer lip of the LB to guide the conductors into the LB. 1) This method does not however protect the conductor jacket from the sides of the outer lip of the LB or from the inner lip once the conductor leaves the roller assembly. 2) This guide is made up of many pieces and would be more expensive to manufacture. 3) This method does not guide the conductors, fed into the straight conduit entrance the LB, out of and away from the LB opening.

### SUMMARY OF THE INVENTION

This is a duel purpose wire guide for installing conductors in electrical conduit LBs.

1. Protects the Conductor Insulation from Damage While it is Being Installed.

The simple design allows the wire guide to be attached to the electrical LB by an existing screw holes on the LB. The conductors can then be easily passed into or out of the LB reducing friction and abrasion on the conductor outer jacket.

2. Protects the Installer from Injury.

To pull conductors through a LB usually requires some force. With this wire guide the conductors can be guided into or out of the LB virtually hands free with very little friction. The installer guides the conductor rather than pushes them through.

The wire guide is made of one piece of polymer material. It has a curved body; the guide is grooved at the end to allow it to be placed on the existing conduit entrance lip at the 90-degree entrance hole of the electrical LB.

The wire guide is then secured to the LB by the holding brackets molded on to the wire guide to the existing screw hole on the Electrical LB. This allows the wire guide to be attached and removed to be reused. The curved design allows the conductors to be guided directly into the attached conduit in the 90-degree conduit entrance hole of the LB. The wire guide can also be placed into and attached to the LB to guide conductors out of the straight entrance hole.

### DESCRIPTION OF DRAWINGS

FIG. 1, Side View of Wire Guide:

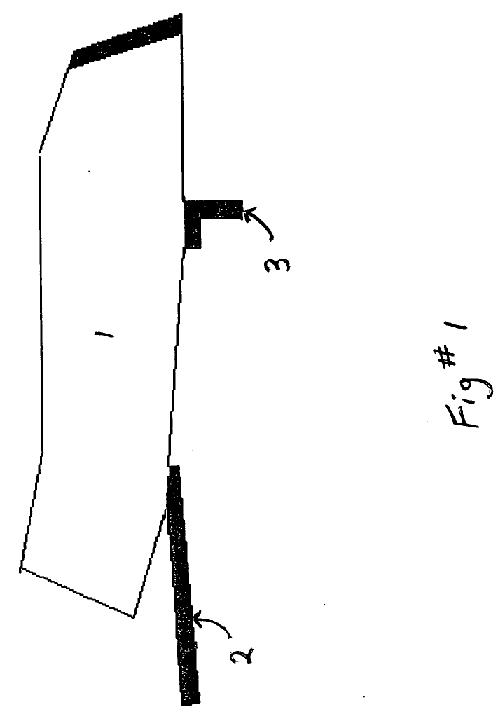

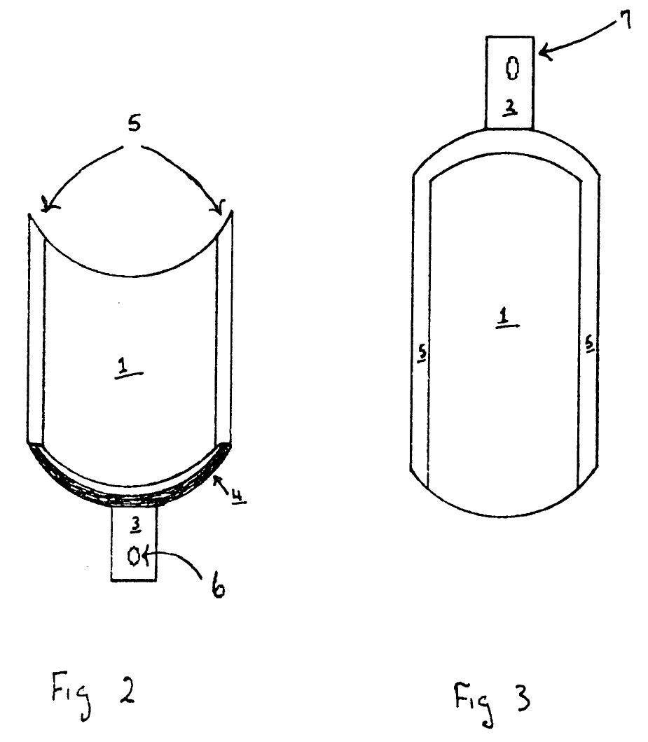

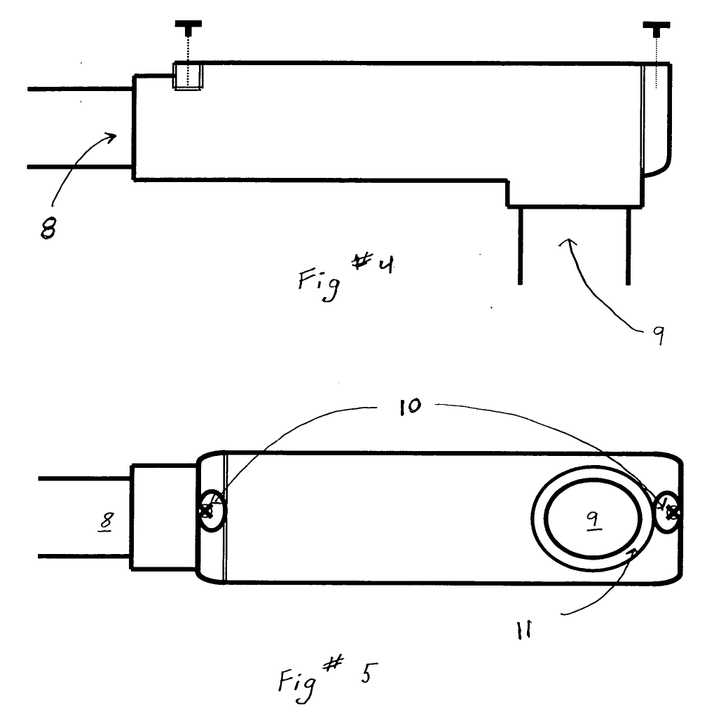

The body (1) is curved to allow the wire to pass through the LB with as little friction as possible. To utilize the Wire Guide for the straight conduit attachment hole of a LB, it is laid into the LB and attached using the holding bracket (2) located on the back of the Wire Guide.

To utilize the Wire Guide for the 90-degree hole of the LB, it is placed vertically up from the hole and attached to the holding bracket (3) located on the bottom. Both brackets are attached to the LB using the existing screw hole on the LB. At the front of the Wire Guide the shaded area (4) is grooved to allow the Wire Guide to form-fit into the LB conduit entrance holes.

FIG. 2, Front View of Wire Guide:

The Wire Guide is curved from side to side (5) to guide the conductors into the LB conduit entrance holes. The 90-degree holding bracket (6) has a slotted hole for easy attachment to the LB. The bottom front of the Wire Guide is grooved out to allow it to form-fit into the LB conduit entrance holes.

FIG. 3, Top View of Wire Guide:

The straight conduit attachment hole holding bracket (7) has a slotted hole for easy attachment of the Wire Guide to the LB. This holding bracket makes sure the Wire Guide stays in place when it is laid into the LB.

FIG. 4: Side View of an Electrical LB:

The straight conduit attachment hole (8) and the 90-degree conduit attachment hole (9) locations are shown in this diagram.

FIG. 5: Top View of an Electrical LB:

The existing screw holes (10) locations and conduit entrance stop lip (11) are shown in this diagram.

### DESCRIPTION USING REFERENCE PICTURES A THROUGH Z4

The Wire Guide is one-piece polymer constructed invention used to reduce friction and abrasions of conductors as they are passed through electrical LBs. It has a curved body with two holding brackets that are molded to the main body of the wire guide. These holding brackets attach the wire guide to electrical LBs (A). The front views show a grooved end to allow the Wire Guide to be placed directly onto the conduit placed in the LB (B, C, D, and E). The middle holding bracket is used to attach the wire guide to the LB utilizing the existing screw hole of the LB.

This allows the Wire Guide to stay in place while it guides the conductors into the 90-degree conduit entrance hole (F, M, N, O, and P). The end holding bracket is used to attach the Wire Guide to the LB utilizing the existing screw hole of the LB. This will allow the Wire Guide to stay in place when guiding the conductors out of the straight attachment hole (G, H, I, J, K and L).

This wire guide can be made to fit different size LBs (Q, R and S) 1¼ and 2 inch are shown, other typical sizes that can be manufactured are ½, ¾, 1, 1½, 3 and 4 inch LBs. If larger LBs are manufactured the Wire Guide can be made to fit. The Wire Guide is attached directly to the incoming conduit in the attachment holes of the LB (G and P). As conductors are feed into the straight attachment hole of the LB, they are guided out of the LB (T, and U). When feeding conductors into the 90-degree conduit attachment hole of the LB, the conductor is guided directly to the attached conduit (V, W, X, Y and Z). The Wire Guide can be used for both electrical and communication wiring (Z1, Z2, Z3 and Z4).

Although the preferred embodiment of the invention has been shown in the drawings and photographs, it has been understood that this disclosure is for the purpose of illustration only and that various changes in material or dimensions may be made without departing from the spirit and scope of the invention set forth in the appended claims.

1. The wire guide is a tool that guides conductors into or out of an electrical LB conduit entrance hole, reducing friction and abrasions on conductor outer jacket insulations. The wire guide has a curved body made of a polymer material with two holding brackets molded to the main body. One holding bracket is located on the back of the main body ⅓ up from the grooved attachment lip. The second holding bracket is located on the back of the main body and protrudes up from the end opposite the grooved end. The holding brackets are attached to the electrical LB by utilizing the existing LB cover screw hole.

2. The wire guide as claimed in claim 1 is made of a polymer material in which makes it easy to manufacture.

3. The wire guide as claimed in claim 1 has two holding brackets molded to the main body in which makes this a one-piece tool.

4. The wire guide as claimed in claim 3 is a one-piece tool in which makes it easy to use.

5. The wire guide as claimed in claim 1 has a grooved main body in which guides conductors directly to the 90-degree conduit entrance hole.

6. The wire guide as claimed in claim 5 guides the conductor directly to the 90-degree conduit entrance hole, which allows the conductor to bypass the LB cover edge and the conduit stop lip when being guided into the 90-degree conduit entrance hole.

7. The wire guide as claimed in claim 1 has a holding bracket located on the back of the main body ⅓ the length of the main body up from the grooved edge, which is utilized to hold the wire guide in place while feeding conductors into the 90-degree conduit entrance hole.

8. The wire guide claimed in claim 1 has a holding bracket located on the back of the main body on the opposite end of the grooved end, which is utilized to hold the wire guide in place when feeding conductors in a conduit that is attached to the conduit straight entrance hole.

9. The wire guide as claimed in claim 1 has two holding brackets, in which are attached to the LB by means of the existing LB cover screw hole.

10. The wire guide as claimed in claim 1 has a main body with a grooved end in which is used to allow the wire guide to form fit the conduit entrance holes.

11. The wire guide as claimed in claim 8 is laid into the LB, which will guide conductors out of the LB when conductors are feed from a conduit into the straight attachment hole of the LB.

12. The wire guide as claimed in claim 1 can be made to fit for ½, ¾, 1, 1½, 3, and 4 inch LBs, which allows the wire guide to be manufactured for any size electrical LB.

13. The wire guide as claimed in claim 1 makes it easer to feed conductors into electrical LB conduit entrance holes, which decreases the work time to finish pulling a conductor through a LB.

14. The wire guide as claimed in claim 12 can be used for any size LB, which allows the wire guide to be used for both electrical and communication wiring.

15. The wire guide as claimed in claim 6 guides a conductor into a 90-degree conduit entrance bypassing the LB cover edge and the conduit stop lip, which will reduce friction and abrasions on the conductor outer jacket insulation.

16. The wire guide as claimed in claim 9 has two holding brackets that are attached to existing LB cover screw hole, which allows the wire guide to be field installable and reusable.
